(19) United States
(12) Patent Application Publication
(10) Pub. No.: US 2009/0237581 A1
(43) Pub. Date: Sep. 24, 2009

(54) LIQUID CRYSTAL DISPLAY AND METHOD FOR MANUFACTURING THE SAME

(76) Inventors: Jae-Sung KIM, Yongin-si (KR); Hoon Kang, Suwon-si (KR); Yang-Ho Jung, Yongin-si (KR); Hi-Kuk Lee, Yongin-si (KR)

Correspondence Address: Haynes and Boone, LLP;IP Section, 2323 Victory Avenue, SUITE 700, Dallas, TX, 75219, US

(21) Appl. No.: 12/267,164

(22) Filed: Nov. 7, 2008

(30) Foreign Application Priority Data
Mar. 19, 2008 (KR) 10-2008-0025429

(51) Int. Cl. G02F 1/1368; G02F 1/13

(52) U.S. Cl. 349/43; 349/187

(57) ABSTRACT

In accordance with one or more embodiments of the present disclosure, a liquid crystal display includes a first substrate, a plurality of first signal lines formed on the first substrate, a plurality of second signal lines intersecting the first signal lines, a plurality of thin film transistors connected to the first signal lines and the second signal lines, an organic insulator formed on the thin film transistors, a plurality of pixel electrodes formed on the organic insulator, a second substrate facing the first substrate, a common electrode formed on the second substrate, a sealant disposed between the first substrate and the second substrate and formed according to the circumference of the second substrate, and a liquid crystal layer interposed between the first substrate and the second substrate and disposed in a region defined by the sealant. The organic insulator includes an opening formed at a position overlapping the sealant.

### CROSS-REFERENCE TO RELATED APPLICATIONS

This application claims priority to and the benefit of Korean Patent Application No. 10-2008-0025429, filed in the Korean Intellectual Property Office on Mar. 19, 2008, the entire contents of which are incorporated herein by reference.

### BACKGROUND

1. Technical Field

The present invention relates to a liquid crystal display and a method for manufacturing the same.

2. Description of Related Art

Generally, liquid crystal displays (LCDs) are one of the most widely used type of flat panel displays. An LCD includes two display panels on which field generating electrodes are formed, and a liquid crystal layer that is interposed between the panels. In the LCD, a voltage is applied to the field generating electrodes so as to generate an electric field, and the alignment of liquid crystal molecules of the liquid crystal layer is determined by the electric field. As such, the transmittance of light passing through the liquid crystal layer is controlled.

The LCD includes field generating electrodes formed at two display panels. A general structure of the LCD includes one display panel having a plurality of pixel electrodes disposed in a matrix form and the other panel having a common electrode covering the whole surface thereof. In the LCD, images are displayed through a voltage separately applied to each pixel electrode. A thin film transistor (TFT), as a three terminal element, is connected to each pixel electrode for switching the voltage applied to the pixel electrode, and a plurality of gate lines transmitting signals to control the thin film transistor and a plurality of data lines transmitting the voltage that is applied to the pixel electrode are provided. The TFT has a switching element for transmitting or blocking the data signals applied through each data line to the pixel electrode according to a scanning signal applied through the gate line.

A passivation layer to protect a channel of the thin film transistor is formed on the thin film transistor. The passivation layer may be an inorganic passivation layer of an inorganic material, or an organic passivation layer of an organic material. The organic passivation layer reduces parasitic capacitance generated between the data line and the pixel electrode such that the pixel electrode and the data line may be overlapped in a predetermined region. As such, the area of the pixel electrode may be sufficiently obtained, thereby increasing the aperture ratio. However, when the organic passivation layer is used, external moisture may permeate through the organic passivation layer such that the thin film transistor and the liquid crystal may be deteriorated.

The above information disclosed in this Background section is only for a general enhancement of understanding of the background of the present disclosure, and therefore, it may include information that does not form the prior art that is already known in this country to a person of ordinary skill in the art.

### SUMMARY

The present disclosure, in accordance with one or more embodiments, may include the desired characteristics of the thin film transistor and the display characteristics of the liquid crystal by preventing deterioration of the thin film transistor and the liquid crystal when using the organic passivation layer.

In accordance with one or more embodiments of the present disclosure, a liquid crystal display includes a first substrate, a plurality of first signal lines formed on the first substrate, a plurality of second signal lines intersecting the first signal lines, a plurality of thin film transistors connected to the first signal lines and the second signal lines, an organic insulator formed on the thin film transistors, a plurality of pixel electrodes formed on the organic insulator, a second substrate facing the first substrate, a common electrode formed on the second substrate, a sealant disposed between the first substrate and the second substrate and formed according to the circumference of the second substrate, and a liquid crystal layer interposed between the first substrate and the second substrate and disposed in the region defined by the sealant. The organic insulator has an opening formed at the position overlapping the sealant.

In various implementations, the opening may be formed according to the sealant with a band shape. The liquid crystal display may include a plurality of protecting members formed in the opening and separated from each other with a predetermined interval therebetween. At least a portion of the first signal lines and the second signal lines may be exposed through the opening, and the protecting members may cover the exposed portion of the first signal lines and the second signal lines. The protecting members may be formed with the same layer as the pixel electrodes. The organic insulator may directly contact the thin film transistors.

In accordance with one or more embodiments of the present disclosure, a liquid crystal display includes a first display panel including a thin film transistor, a pixel electrode connected to the thin film transistor, and an organic insulator disposed between the thin film transistor and the pixel electrode; a second display panel including a common electrode facing the pixel electrode; a sealant adhering and fixing the first display panel and the second display panel to each other and having a band shape; and a liquid crystal layer interposed between the first display panel and the second display panel and enclosed in the region defined by the sealant, wherein the organic insulator includes a first portion disposed inside the region enclosed by the sealant and a second portion disposed outside the region enclosed by the sealant, and the first portion and the second portion of the organic insulator are separated from each other.

In various implementations, the liquid crystal display may include a plurality of protecting members disposed between the first portion and the second portion of the organic insulator and separated from each other. The first display panel further may include a signal line connected to the thin film transistor, a portion of the signal line may be exposed between the first portion and the second portion of the organic insulator, and the protecting members may cover the exposed portion of the signal line. The protecting members may be formed with the same layer as the pixel electrodes.

In accordance with one or more embodiments of the present disclosure, a liquid crystal display includes a first display panel including a signal line, an organic insulator formed on the signal line, and a pixel electrode formed on the organic insulator; a second display panel having a common electrode facing the pixel electrode; a sealant disposed between the first display panel and the second display panel and formed according to the circumference of the second display panel; and a liquid crystal layer interposed between the first display panel and the second display panel and enclosed in the region defined by the sealant, wherein the organic insulator is removed under the sealant.

In various implementations, a portion of the signal line may be exposed through the removed portion of the organic insulator, and the liquid crystal display may include a plurality of protecting members covering the exposed portion of the signal line. The protecting members may be formed with the same layer as the pixel electrodes.

In accordance with one or more embodiments of the present disclosure, a method for manufacturing a liquid crystal display includes forming a signal line and a thin film transistor connected to the signal line on a first substrate, forming an organic insulator on the signal line and the thin film transistor, forming a plurality of contact holes exposing the signal line and the thin film transistor and an opening exposing the portion of the signal line with a band shape in the organic insulator, forming a pixel electrode connected to the thin film transistor, forming a common electrode on a second substrate, forming a sealant with a band shape on the first substrate or the second substrate, assembling the first substrate and the second substrate, and forming a liquid crystal layer between the first substrate and the second substrate.

In various implementations, the sealant may be formed on the position overlapping the opening. The manufacturing method may include forming a plurality of protecting members disposed in the opening and separated from each other. The protecting members may cover the exposed portion of the signal line. The protecting members may be formed along with the pixel electrode. A deposition process may not be executed between the process of forming the signal line and the thin film transistor and the process of forming the organic insulator.

In accordance with one or more embodiments of the present disclosure, the organic passivation layer is formed such that the parasitic capacitance generated between the data line and the pixel electrode may be reduced, and the area of the pixel electrode may be sufficiently obtained to thereby maximize the aperture ratio. In one implementation, an additional inorganic passivation layer is not disposed under the organic passivation layer such that a process such as deposition to form the additional inorganic passivation layer may be omitted, therefore simplifying the manufacturing process.

In accordance with one or more embodiments of the present disclosure, the sealant divides the organic insulator such that external moisture may not flow into the display panel through the organic passivation layer. As such, the deterioration of the thin film transistor and liquid crystal due to the moisture may be prevented. In one aspect, the protecting member covers the signal line in the opening of the organic passivation layer such that the signal line may be prevented from being exposed through the opening and being etched and damaged when forming the pixel.

### BRIEF DESCRIPTION OF THE DRAWINGS

FIG. 1 is a perspective view of a liquid crystal display, according to an exemplary embodiment of the present disclosure.

FIG. 2 is a layout view of the liquid crystal display shown in FIG. 1.

FIG. 3 is a cross-sectional view of the liquid crystal display shown in FIG. 2 taken along the line III-III.

FIG. 4 to FIG. 9 are cross-sectional view sequentially showing the manufacturing method of the thin film transistor array panel, according to an exemplary embodiment of the present disclosure.

### DETAILED DESCRIPTION

The present disclosure will be described more fully hereinafter with reference to the accompanying drawings, in which exemplary embodiments of the present disclosure are shown. As those skilled in the art would realize, the described embodiments may be modified in various different ways, all without departing from the spirit or scope of the present disclosure.

In the drawings, the thickness of layers, films, panels, regions, etc., are exaggerated for clarity. Like reference numerals designate like elements throughout the specification. It will be understood that when an element such as a layer, film, region, or substrate is referred to as being “on” another element, it can be directly on the other element or intervening elements may also be present. In contrast, when an element is referred to as being “directly on” another element, there are no intervening elements present.

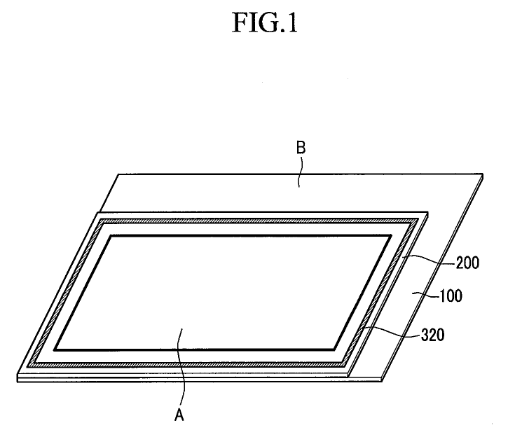

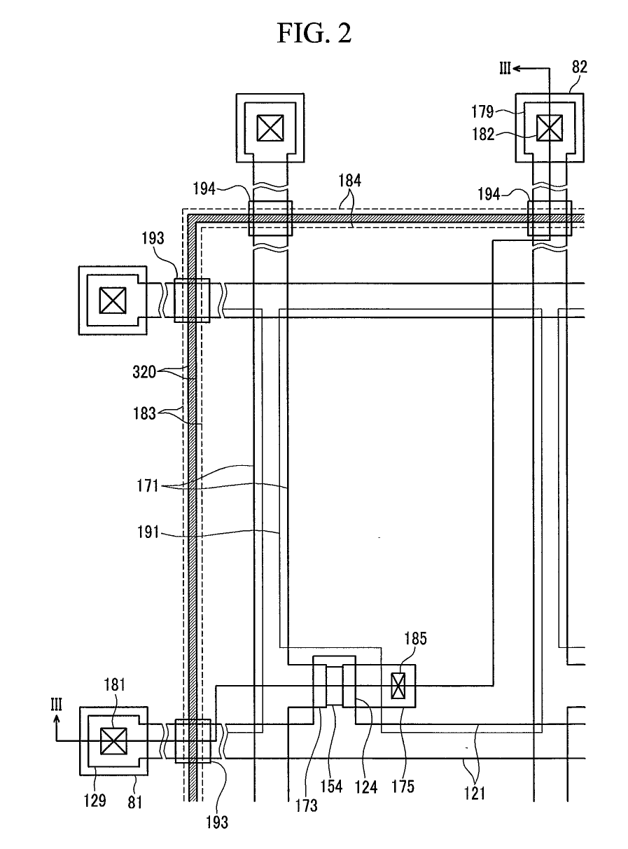

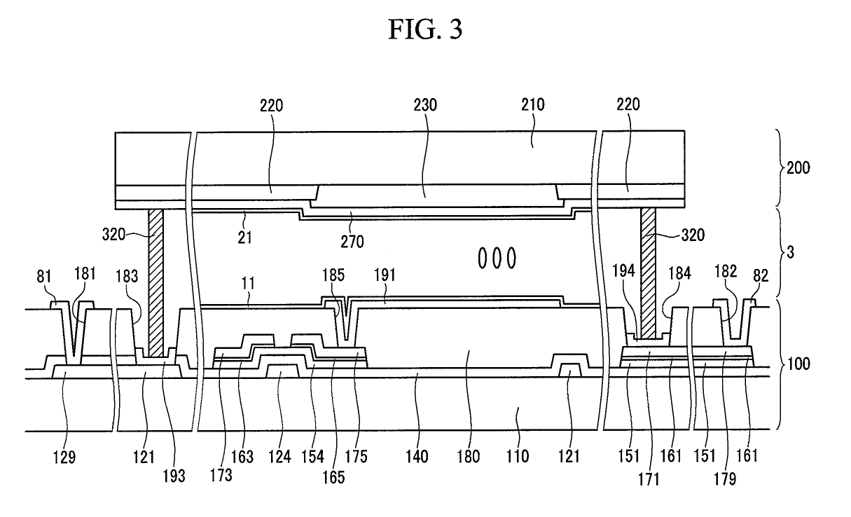

An LCD according to an exemplary embodiment of the present disclosure will be described with reference to FIG. 1 to FIG. 3. In particular, FIG. 1 is a perspective view of an LCD, according to an exemplary embodiment of the present disclosure, FIG. 2 is a layout view of the LCD shown in FIG. 1, and FIG. 3 is a cross-sectional view of the LCD shown in FIG. 2 taken along the line III-III.

Referring to FIG. 1 to FIG. 3, an LCD according to an embodiment of the present disclosure includes a TFT array panel 100 and a common electrode panel 200 facing each other, and a liquid crystal layer 3 interposed between two display panels 100 and 200. The TFT array panel 100 and the common electrode panel 200 are attached and fixed by a sealant 320 with a band shape, and the liquid crystal layer 3 is disposed in a region defined by the sealant 320. The LCD includes a display area A for the display of images, and a pad region B for connection with external driving circuits. In the display area A, a plurality of TFTs are arranged with a matrix shape, and the TFTs are connected to gate lines 121 and data lines 171 extending in different directions. One end of the gate lines 121 and the data lines 171 include a portion having a wide width for connection to the external circuits, and they are called gate pads 129 and data pads 179, respectively. The gate pads 129 and the data pads 179 are disposed in the pad region B.

In accordance with an embodiment of the present disclosure, the TFT array panel 100 is described herein. A plurality of gate lines 121 transmitting gate signals are formed on an insulating substrate 110. Each gate line 121 is extended in a transverse direction and includes a plurality of gate electrodes 124 extending upward and the gate pad 129 disposed on the end thereof.

A gate insulating layer 140, in one embodiment, is formed on the gate lines 121, and a plurality of semiconductor stripes 151 extending in a longitudinal direction and preferably made of amorphous or crystallized silicon are formed on the gate insulating layer 140. The semiconductor stripes 151 include a plurality of protrusions 154 extending toward the gate electrodes 124.

In one embodiment, a plurality of ohmic contact stripes 161 and a plurality of ohmic contact islands 165 preferably made of silicide or n+ hydrogenated amorphous silicon (a-Si) heavily doped with an n-type impurity, such as phosphorus (P), are formed on the semiconductor stripes 151. The ohmic contact stripes 161 include a plurality of protrusions 163 extending toward the protrusions 154 of the semiconductor stripes 151, and the protrusions 163 and the ohmic contact islands 165 are disposed in pairs on the protrusions 154 of the semiconductor stripes 151. A plurality of data lines 171 and a plurality of drain electrodes 175 are formed on the ohmic contact stripes 161, the ohmic contact islands 165, and the gate insulating layer 140.

In one embodiment, the data lines 171 extending substantially in the longitudinal direction intersect the gate lines 121, and transmit data signals. Each of the data lines 171 includes a plurality of source electrodes 173 branched out toward the gate electrodes 124 and the data pad 179. A source electrode 173 and a drain electrode 175 forming a pair are opposite to each other on the gate electrode 124. A gate electrode 124, a source electrode 173, and a drain electrode 175 form a thin film transistor (TFT) along with a protrusion 154 of a semiconductor stripe 151, and the channel of the TFT is formed on the protrusion 154 of the semiconductor stripe 151 between the source electrode 173 and the drain electrode 175.

The semiconductor stripes 151 except for the channel regions between the source electrode 173 and the drain electrode 175 have substantially the same plane shape as the data lines 171 and the drain electrodes 175. The ohmic contact stripes 161 are interposed only between the semiconductor stripes 151 and the data lines 171, and have substantially the same plane shape as the data lines 171. The ohmic contact islands 165 are interposed only between the semiconductor stripes 151 and the drain electrodes 175, and have substantially the same plane shape as the drain electrode 175.

In one embodiment, an organic passivation layer 180 is formed on the data lines 171 and the drain electrodes 175. The organic passivation layer 180 may be made of an organic insulating material of a low dielectric constant such as acryl-based compound or benzocyclobutene (BCB). The organic passivation layer 180 may have a thickness of about 1 to 4 micrometers, and is a single layer. The data lines 171 and drain electrodes 175 and the organic passivation layer 180 directly contact each other, and an inorganic passivation layer made of an inorganic material is not interposed therebetween. In this way, the additional inorganic passivation layer does not exist under the organic passivation layer such that a process to activate the inorganic passivation layer may be omitted, thereby simplifying the manufacturing process.

In one implementation, the organic passivation layer 180 is formed thicker than the inorganic passivation layer such that parasitic capacitance generated between the data lines 171 and the pixel electrodes 191 may be reduced. As such, the pixel electrodes 191 and the data lines 171 may be overlapped on the predetermined region such that the area of the pixel electrodes 191 may be sufficiently obtained, thereby increasing the aperture ratio. The organic passivation layer 180 includes a plurality of contact holes 185 and 182 respectively exposing the drain electrodes 175 and the data pads 179, and the gate insulating layer 140 and the organic passivation layer 180 include a plurality of contact holes 181 exposing the gate pads 129.

In one implementation, the organic passivation layer 180 has a plurality of openings 183 and 184 formed according to the circumference of the display area A having a band shape. The openings 183 and 184 include longitudinal openings 183 extending in the longitudinal direction and transverse openings 184 extending in the transverse direction.

In one embodiment, the gate insulating layer 140 exposed through the longitudinal opening 183 is removed, and the portion of the gate lines 121 disposed thereunder is exposed. The width of the exposed gate line 121, that is, the short edge direction of the gate line 121, is completely exposed. However, the gate insulating layer 140 disposed under the opening 183 may not be removed and the portion of the gate line 121 may not be exposed. The transverse opening 184 exposes the portion of the data line 171 disposed thereunder, and the width of the exposed data line 171, that is, the short edge direction of the data line, is completely exposed. A pair of longitudinal openings 183 and a pair of transverse openings 184 form a rectangular band shape. A plurality of pixel electrodes 191, a plurality of protecting members 193 and 194, and a plurality of contact assistants 81 and 82 are formed on the organic passivation layer 180. The pixel electrodes 191 are connected to the drain electrodes 175 through the contact holes 185 to receive the data voltages from the drain electrodes 175.

In one embodiment, the protecting members 193 and 194 are formed in the openings 183 and 184 and are separated from each other by a predetermined interval according to the longitudinal and transverse directions. The protecting members 193 cover the gate lines 121 exposed through the longitudinal openings 183, and the protecting members 194 cover the data lines 171 exposed through the transverse openings 184. The protecting members 193 and 194 have an island shape. It may be desirable that they have sufficient size to completely cover the exposed portions of the gate lines 121 and the data lines 171. When the gate insulating layer 140 disposed under the opening 183 is not removed, the gate line 121 is not exposed such that the protecting member 193 may be omitted. In one aspect, the protecting members 193 and 194 prevent the gate lines 121 and/or data lines 171 exposed through the openings 183 and 184 from being etched or damaged when forming the pixel electrodes 191.

In one embodiment, the contact assistants 81 and 82 are connected through the contact holes 181 and 182 to the gate and data pads 129 and 179 of the gate and data lines 121 and 171, respectively. The contact assistants 81 and 82 have a function of enhancing the adhesion of the gate and the data pads 129 and 179 of the gate lines 121 and the data lines 171 to external apparatuses, and of protecting them.

In accordance with an embodiment of the present disclosure, the common electrode panel 200 is described herein. A light blocking member 220 is formed on an insulating substrate 210 that is preferably made of transparent glass or plastic. The light blocking layer 220 may be referred to as a black matrix. The light blocking member 220 has a plurality of openings facing the pixel electrodes 191 and having almost the same shape as the pixel electrodes 191 for preventing light leakage between the pixel electrodes 191. The light blocking member 220 may include a portion corresponding to the gate lines 121 and the data lines 171 and a portion corresponding to the TFTs.

A plurality of color filters 230, in one embodiment, are formed on the substrate 210. The color filters 230 are disposed substantially in the areas enclosed by the light blocking member 220, and they may extend in one direction. Each of the color filters 230 may represent one of primary colors such as red, green, and blue.

A common electrode 270, in one embodiment, is formed on the color filters 230. The common electrode 270 and a pixel electrode 191 form a pair of field generating electrodes.

Alignment layers 11 and 21, in one embodiment, are formed inside surfaces of the TFT array panel 100 and the common electrode panel 200, and polarizers (not shown) are attached on the outer surfaces thereof.

In one embodiment, the TFT array panel 100 and the common electrode panel 200 are adhered and fixed by the sealant 320. The sealant 320 is formed according to the circumference of the display area A to define a region of a predetermined enclosed shape, and has substantially the same height as the cell gap.

The organic passivation layer 180, in one embodiment, is removed under the sealant 320. That is, the sealant 320 is disposed with a band shape on the position overlapping the openings 183 and 184 of the organic passivation layer 180, and the sealant 320 may be wider or narrower than the openings 183 and 184. The sealant 320 overlaps the openings 183 and 184 of the organic passivation layer 180 such that the sealant 320 may divide the organic passivation layer into a first portion disposed in the enclosed region and a second portion out the enclosed region. That is, the sealant 320 may divide the organic passivation layer 180 into two parts, the first and second portions.

The liquid crystal layer 3, in one embodiment, is interposed between the TFT array panel 100 and the common electrode panel 200. The liquid crystal layer 3 is disposed in the region defined by the sealant 320 and includes a plurality of liquid crystals 310. The liquid crystals 310 have negative or positive dielectric anisotropy, and liquid crystal molecules of the liquid crystal layer 3 are aligned such that their longer axes are substantially perpendicular or parallel to the surfaces of the two display panels 100 and 200 in a state in which no electric field is applied, and are realigned in a state in which an electric field is applied between the common electrode 270 and the pixel electrodes 191.

According to an exemplary embodiment of the present disclosure, the sealant 320 and the openings 183 and 184 of the organic passivation layer 180 overlap each other such that the sealant 320 divides the organic passivation layer. The path through which the external moisture flows into the display panel through the organic passivation layer is disconnected such that the deterioration of the TFT and the liquid crystal may be prevented. Also, the openings 183 and 184 are formed in the organic passivation layer 180 to disconnect the path of the flow of the external moisture, and the plurality of protecting members 193 and 194 are formed in the openings 183 and 184 such that the protecting members 193 and 194 prevent the exposed gate lines 121 and/or the data line 171 from being etched or damaged through the openings 183 and 184 when forming the pixel electrodes 191.

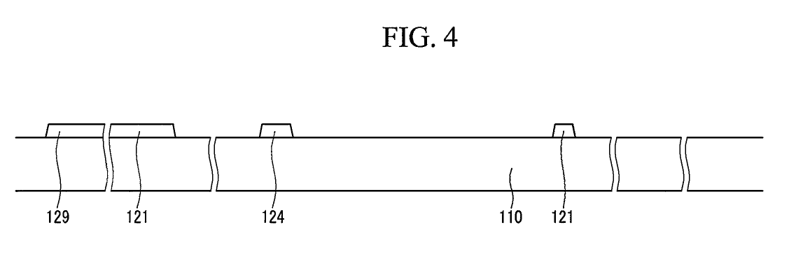

In accordance with one or more embodiments of the present disclosure, a method for manufacturing the LCD shown in FIG. 1 to FIG. 3 is described herein with reference to FIG. 4 to FIG. 9 as well as FIG. 1 to FIG. 3. FIG. 4 to FIG. 9 are cross-sectional views sequentially showing a manufacturing method of the TFT array panel, according to an exemplary embodiment of the present disclosure.

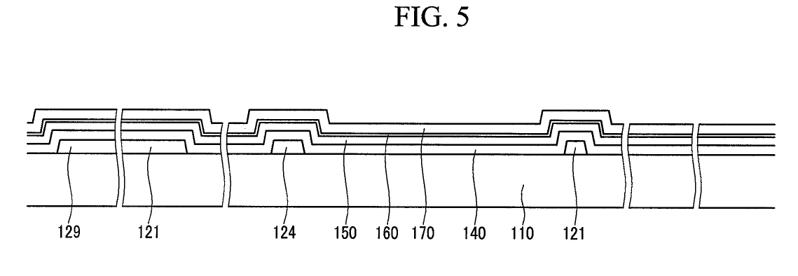

Referring to FIG. 4, a gate conductive layer (not shown) is laminated on an insulating substrate 110 and patterned by photolithography to form a plurality of gate lines 121 including a plurality of gate electrodes 124 and gate pads 129. Next, referring to FIG. 5, a gate insulating layer 140, a semiconductor layer 150, a doped semiconductor layer 160, and a data conductive layer 170 are sequentially laminated on the substrate 110.

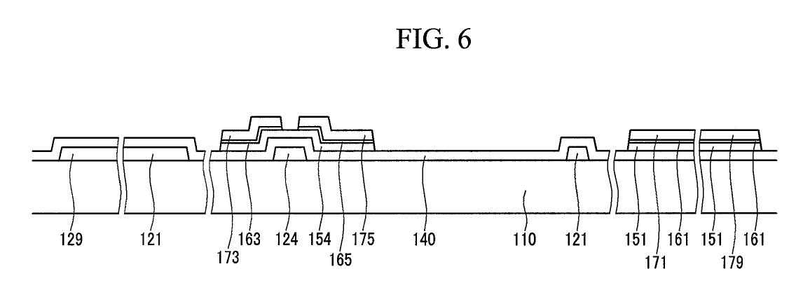

Referring to FIG. 5 and 6, a photoresist pattern having different thicknesses according to positions is then formed on the data conductive layer 170, and the data conductive layer 170, the doped semiconductor layer 160, and the semiconductor layer 150 are firstly patterned by photolithography by using the photoresist pattern as an etch mask to form a plurality of data lines 171 including a plurality of data pads 179, a plurality of ohmic contact layers 161, and a plurality of semiconductor stripes 151. Next, a portion of the photoresist pattern is removed and the data lines 171 are secondarily etched by using the remaining photoresist pattern as an etch mask to complete a plurality of source electrodes 173 and drain electrodes 175. A back channel etch (BCE) is then executed by using the source electrodes 173 and the drain electrodes 175 as an etch mask to form a plurality of ohmic contact stripes 161 including a plurality of protrusions 163 and ohmic contact islands 165.

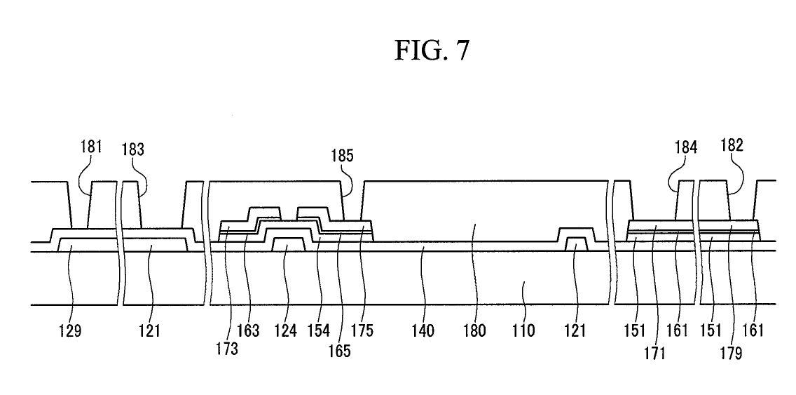

Referring to FIG. 7, an organic passivation layer 180 is then formed on the whole surface of the substrate including the data lines 171, the drain electrodes 175, and the gate insulating layer 140. The organic passivation layer 180 may be coated using spin coating, slit coating, or spin and slit coating. Next, the organic passivation layer 180 is exposed and developed to form a plurality of contact holes 181, 182, and 185 and a plurality of openings 183 and 184 with a band shape.

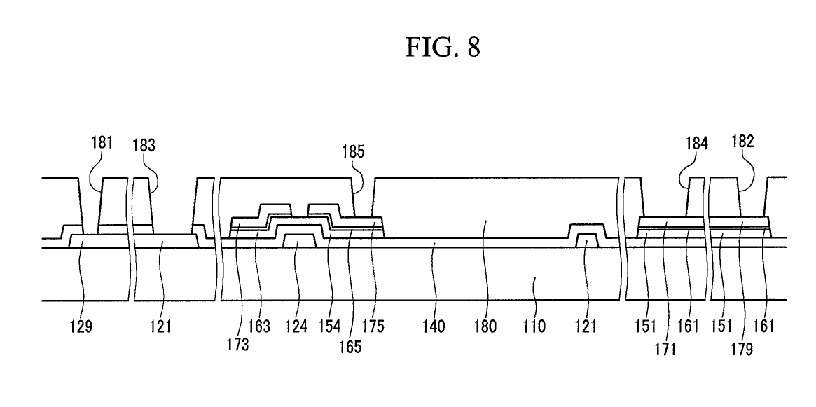

Referring to FIG. 8, the gate insulating layer 140 disposed under the contact holes 181 and the opening 183 is then removed. However, the gate insulating layer 140 disposed under the opening 183 may not be removed. The contact holes 181, 182, and 185 respectively expose the gate pads 129, the data pads 179, and the drain electrodes 175, and the openings 183 and 184 expose the portions of the gate lines 121 and the data lines 171.

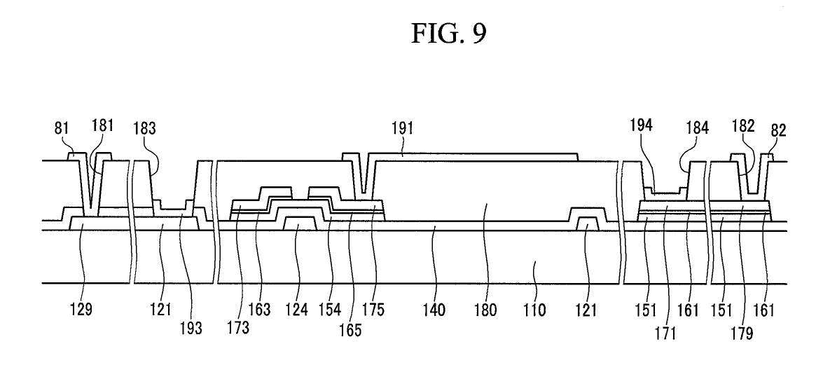

Next, referring to FIG. 9, a conductive layer (not shown) such as a transparent conductor or an opaque conductor is laminated on the organic passivation layer 180 and patterned by photolithography to form a plurality of pixel electrodes 191, a plurality of protecting members 193 and 194, and a plurality of contact assistants 81 and 82. Here, the pixel electrodes 191 are connected to the drain electrodes 175 through the contact holes 185, the protecting members 193 and 194 cover the exposed gate lines 121 and the data lines 171 through the openings 183 and 184, and the contact assistants 81 and 82 are connected to the gate pads 129 and the data pads 179 through the contact holes 181 and 182. The protecting members 193 and 194 completely cover the exposed gate lines 121 and the data lines 171 through the openings 183 and 184 such that the gate lines 121 and the data lines 171 may be prevented from being etched or damaged by the etchant during the photolithography. In accordance with an embodiment of the present disclosure, an alignment layer 11 is coated on the pixel electrodes 191. Sphere spacers (not shown) are then dispersed on the TFT array panel 100. The sphere spacers are uniformly dispersed on the TFT array panel 100 by using a spacer disperser (not shown). A plurality of liquid crystals 310 are dripped on the TFT array panel 100 by using a liquid crystal dripper (not shown). The liquid crystal dripper may drip the liquid crystals 310 at predetermined positions by moving on the TFT array panel 100 in upper, lower, left, and right directions.

In accordance with one or more embodiments of the present disclosure, a method for manufacturing the common electrode panel 200 is described herein with reference to FIG. 1 to FIG. 3. A light blocking member 220 made of an opaque metal or an organic material is formed on a substrate 210. A plurality of color filters 230 are formed thereon. To form the color filters 230, photosensitive organic materials including pigments of red, green, and blue are coated and patterned by a photo process, or are Ink-jet printed. A transparent conductive layer, such as ITO or IZO, is then sputtered on the whole surface of the color filters 230 and the light blocking member 220 and patterned to form a common electrode 270, and an alignment layer 21 is formed thereon.

Next, a sealant 320 is formed on the area outside the display area A of the common electrode panel 200. The sealant 320 may be formed with a band shape by using a dispenser, and the height and width of the sealant 320 may be controlled according to the emission amount. Here, the sealant 320 may have the same thickness as a cell gap or a greater thickness than the cell gap when considering a compression degree thereof. The TFT array panel 100 and the common electrode panel 200 are then assembled. It is preferable that the assembly process is executed in a vacuum. The sealant 320 between the TFT array panel 100 and the common electrode panel 200 is hardened by UV light. Also, if necessary, a thermal hardening process may be added.

In the above-described exemplary embodiment, the liquid crystals 310 are dripped on the TFT array panel 100 and the sealant 320 is formed on the common electrode panel 200, but alternatively, the liquid crystals 310 may be dripped on the common electrode panel 200 and the sealant 320 may be formed on the TFT array panel 100, or the liquid crystals 310 and the sealant 320 may be formed on the same display panel.

Also, in the above-described exemplary embodiment, the liquid crystals 310 are dripped, but it is not limited thereto, and the liquid crystals 310 may be injected by using the capillary phenomenon after the assembly of the TFT array panel 100 and the common electrode panel 200.

While this present disclosure has been described in connection with what is presently considered to be practical exemplary embodiments, it is to be understood that the present disclosure is not limited to the disclosed embodiments, but, on the contrary, is intended to cover various modifications and equivalent arrangements included within the spirit and scope of the appended claims.

What is claimed is:

1. A liquid crystal display comprising:
a first substrate;
a plurality of first signal lines formed on the first substrate;
a plurality of second signal lines intersecting the first signal lines;
a plurality of thin film transistors connected to the first signal lines and the second signal lines;
an organic insulator formed on the thin film transistors;
a plurality of pixel electrodes formed on the organic insulator;
a second substrate facing the first substrate;
a common electrode formed on the second substrate;
a sealant disposed between the first substrate and the second substrate, the sealant formed according to the circumference of the second substrate; and
a liquid crystal layer interposed between the first substrate and the second substrate, the liquid crystal layer disposed in a region defined by the sealant, wherein the organic insulator has an opening formed at a position overlapping the sealant.

2. The liquid crystal display of claim 1, wherein the opening is formed according to the sealant with a band shape.

3. The liquid crystal display of claim 2, further comprising a plurality of protecting members formed in the opening and separated from each other by a predetermined interval.

4. The liquid crystal display of claim 3, wherein at least a portion of the first signal lines and the second signal lines is exposed through the opening, and wherein the protecting members cover the exposed portion of the first signal lines and the second signal lines.

5. The liquid crystal display of claim 4, wherein the protecting members are formed with the same layer as the pixel electrodes.

6. The liquid crystal display of claim 1, wherein the organic insulator directly contacts the thin film transistors.

7. A liquid crystal display comprising:
a first display panel including a thin film transistor, a pixel electrode connected to the thin film transistor, and an organic insulator disposed between the thin film transistor and the pixel electrode;
a second display panel including a common electrode facing the pixel electrode;
a sealant adhering and fixing the first display panel and the second display panel to each other and having a band shape; and
a liquid crystal layer interposed between the first display panel and the second display panel, the liquid crystal layer enclosed in the region defined by the sealant,
wherein the organic insulator includes:
a first portion disposed inside the region enclosed by the sealant; and
a second portion disposed outside the region enclosed by the sealant,
wherein the first portion and the second portion of the organic insulator are separated from each other.

8. The liquid crystal display of claim 7, further comprising a plurality of protecting members disposed between the first portion and the second portion of the organic insulator and separated from each other.

9. The liquid crystal display of claim 8, wherein the first display panel further includes a signal line connected to the thin film transistor, wherein a portion of the signal line is exposed between the first portion and the second portion of the organic insulator, and wherein the protecting members cover the exposed portion of the signal line.

10. The liquid crystal display of claim 9, wherein the protecting members are formed with the same layer as the pixel electrode.

11. A liquid crystal display comprising:
a first display panel including a signal line, an organic insulator formed on the signal line, and a pixel electrode formed on the organic insulator;
a second display panel having a common electrode facing the pixel electrode;
a sealant disposed between the first display panel and the second display panel, the sealant formed according to the circumference of the second display panel; and
a liquid crystal layer interposed between the first display panel and the second display panel, the liquid crystal layer enclosed in a region defined by the sealant,
wherein the organic insulator is removed under the sealant.

12. The liquid crystal display of claim 11, wherein a portion of the signal line is exposed through the removed portion of the organic insulator, and wherein the liquid crystal display further includes a plurality of protecting members covering the exposed portion of the signal line.

13. The liquid crystal display of claim 12, wherein the protecting members are formed with the same layer as the pixel electrode.

14. A method for manufacturing a liquid crystal display, the method comprising:
forming a signal line and a thin film transistor connected to the signal line on a first substrate;
forming an organic insulator on the signal line and the thin film transistor;
forming a plurality of contact holes exposing the signal line and the thin film transistor and an opening exposing the portion of the signal line with a band shape in the organic insulator;
forming a pixel electrode connected to the thin film transistor;
forming a common electrode on a second substrate;
forming a sealant with a band shape on the first substrate or the second substrate;
assembling the first substrate and the second substrate; and
forming a liquid crystal layer between the first substrate and the second substrate.

15. The method of claim 14, wherein the sealant is formed at a position overlapping the opening.

16. The method of claim 15, further comprising forming a plurality of protecting members disposed in the opening and separated from each other.

17. The method of claim 16, wherein the protecting members cover the exposed portion of the signal line.

18. The method of claim 16, wherein the protecting members are formed along with the pixel electrode.

19. The method of claim 14, wherein a deposition process is not executed between forming the signal line and the thin film transistor and forming the organic insulator.
